(19) United States
(12) Patent Application Publication
(10) Pub. No.: US 2017/0288504 A1
(43) Pub. Date: Oct. 5, 2017

(54) SYSTEMS AND METHODS FOR COOLING ELECTRONICS AND A REAR END OF STATOR WINDINGS IN AN ALTERNATOR

(71) Applicant: Prestolite Electric, Inc., Novi, MI (US)

(72) Inventors: Zoltan Takacs, Pilisvorosvar (HU); Michael J. Hanchett, Lapeer, MI (US)

(21) Appl. No.: 15/088,779

(22) Filed: Apr. 1, 2016

(51) Int. Cl. H02K 9/06; F04D 29/58; F04D 29/28; F04D 29/42; F04D 17/16; F04D 25/06

(52) U.S. Cl. CPC H02K 9/06; F04D 17/164; F04D 25/06; F04D 29/281; F04D 29/4206; F04D 29/584

(57) ABSTRACT

Systems and methods are provided for cooling electronics and rear end stator windings in an alternator. The system includes an alternator having a rotor assembly, stator assembly, and dual-sided fan disposed in a housing. The housing includes a drive end, rear end, and sides. The rotor assembly includes drive end and rear end poles. The stator assembly surrounds the poles and includes drive end and rear end stator windings. The dual-sided fan is mounted to the rotor assembly adjacent the rear end poles within the housing. The dual-sided fan includes a separating wall, drive end blade set, and rear end blade set. The drive end blade set extends from a first side of the separating wall and at least partially faces the drive end. The rear end blade set extends from a second side of the separating wall and at least partially faces the rear end.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD

Certain embodiments of the invention relate to systems and methods for cooling electronics and a rear end of stator windings in an alternator. More specifically, certain embodiments provide a rear end alternator internal dual-sided fan having a rear end blade set that pulls air from a rear end of an alternator to cool electronics in the alternator, and a drive end blade set that pulls air from a drive end of the alternator to cool a rear end of stator windings in the alternator.

### BACKGROUND

Alternators are electromechanical devices that convert mechanical energy to alternating current. FIG. 1 is a vertical cross-sectional view, taken along the longitudinal axis of a rotor assembly shaft 11, of an exemplary alternator 1 and conventional air flow paths 80, 81, 90 as is known in the art. FIG. 2 is a perspective, vertical cross-sectional view, taken along the longitudinal axis of a rotor assembly shaft 11, of a portion of an exemplary alternator 1 and conventional air flow paths 80, 81, 90 as is known in the art. Referring to FIGS. 1 and 2, the exemplary alternator 1 may comprise, as an example, a drive end housing 70, a rear end housing 71, conventional main air flow paths 80, 81, 90, air flow inlets 83, 91, air flow outlets 85, 92, a rotor assembly 10, a stator assembly 20, rectifiers 30, a regulator 40, a drive end internal fan 50, and a rear end internal fan 60, among other things.

The regulator 40 is an electronic component disposed at the rear end of the alternator 1. The regulator 40 controls the alternator 1 output by monitoring the battery (not shown) and stator assembly 20 voltages. The regulator 40 adjusts the amount of rotor field current to control the alternator 1 output based on the measured voltages. The rotor assembly 10 may comprise a shaft 11, drive end rotor poles 12, rear end rotor poles 13, and a field coil 14, for example. The field coil 14 may be wound over an iron core that may be a part of the shaft 11. The drive end rotor poles 12 and rear end rotor poles 13 may surround the field coil 14. The shaft 11 may be connected with, for instance, a pulley, not shown, that may be driven by the engine of a motor vehicle, also not shown. The field coil 14 creates a magnetic field and spinning of the drive end rotor poles 12 and rear end rotor poles 13 with the shaft 11 creates an alternating magnetic field that induces an alternating voltage into the stator windings 21, 22 of the stator assembly 20. The stator assembly 20 outputs an AC voltage that is converted to a DC voltage by the rectifiers 30. The DC voltage is outputted by the alternator 1 to the battery (not shown).

During operation, various components of the alternator 1, such as the rectifier assembly 30, regulator 40, and stator windings 21, 22 of the stator assembly 20, generate heat that may limit the effectiveness of the components and cause them to break down more quickly over time. Accordingly, current alternators 1 may include an internal drive end fan 50 and an internal rear end fan 60 to promote air circulation. The drive end fan 50 may be mounted on the drive end rotor poles 12 for rotation with the rotor poles 12 at the drive end of the alternator 1. Rotation of the drive end fan 50 pulls air in at a drive end air inlet 91, along a conventional drive end fan air flow path 90, and expels the air out the sides of the alternator 1 at a drive end air outlet 92 over the drive end stator windings 21 of the stator assembly 20. Thus, the drive end fan 50 may use ambient air pulled in from the drive end air inlet 91 to cool the drive end stator windings 21.

The rear end fan 60 may be mounted on the rear end rotor poles 13 for rotation with rotor poles 13 at the rear end of the alternator 1. Rotation of the rear end fan 60 pulls air in at a rear end air inlet 83, along a conventional rear end fan air flow path 80 across the regulator 40 and/or rectifiers 30, and expels the air out the sides of the alternator 1 at a rear end air outlet 85 over the rear end stator windings 22 of the stator assembly 20. Accordingly, the rear end fan 60 may use ambient air pulled in from the rear end air inlet 83 to first cool the regulator 40 and/or rectifiers 30. The air warmed by the regulator 40 and/or rectifiers may then be used to attempt to cool the rear end stator windings 22 of the stator assembly 20. In some cases, a small amount of air flow 81 (e.g., less than air flow 80) from the drive end air inlet 91 may also be pulled by the rear end fan 60 and/or blown by the drive end fan 50 through an air gap 17 between the drive end rotor pole 12 and rear end rotor pole 13. The air flow 81 may be expelled with the conventional rear end fan air flow path 80 over the rear end stator windings 22 of the stator assembly 20 and out the rear end air outlet 85 at the sides of the alternator 1.

The current conventional main air flow paths 80, 81, 90 in alternators 1 have limited effectiveness cooling the rear end stator windings 22 of the stator assembly 20. For example, the drive end fan air flow 90 does not pass over the rear end stator windings 22. Moreover, the air flow 80 from the rear end air inlet 83 flowing over the rear end stator windings 22 is pre-heated by the rectifiers 30 and regulator 40. Furthermore, the air 81 from the drive end air inlet 91 is too small to counter the effects of the hot air blown on the rear stator windings 22 from the rear end air flow 80. The ineffective cooling of the rear end stator windings 22 may reduce the performance and life of the alternator 1.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY

Systems and methods for cooling electronics and a rear end of stator windings in an alternator are provided, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a vertical cross-sectional view, taken along the longitudinal axis of a rotor assembly shaft, of an exemplary alternator and conventional air flow paths as is known in the art.

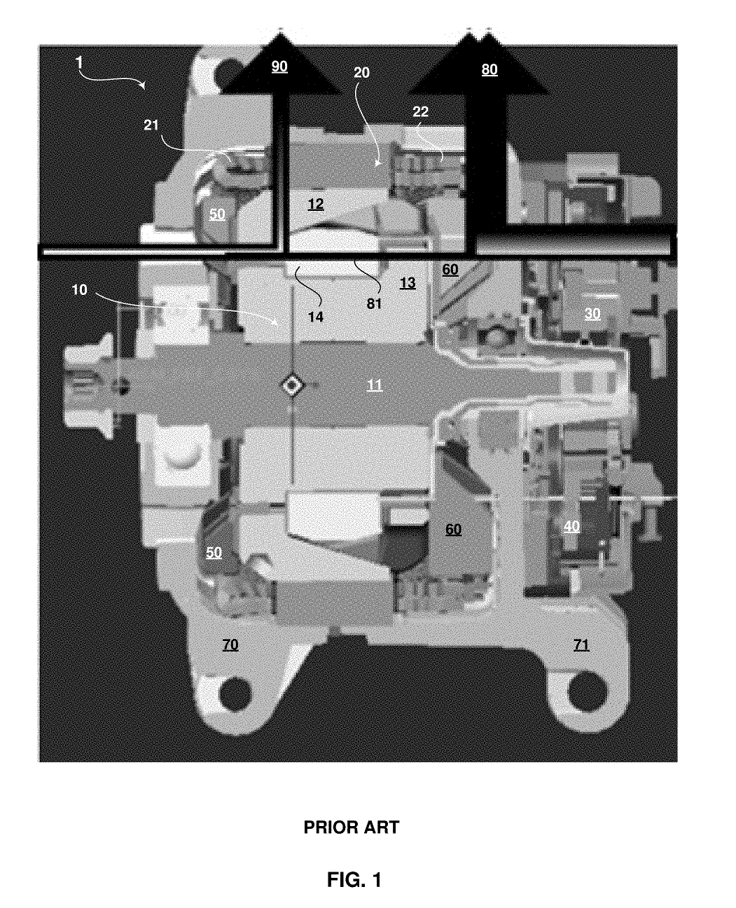

FIG. 2 is a perspective, vertical cross-sectional view, taken along the longitudinal axis of a rotor assembly shaft, of a portion of an exemplary alternator and conventional air flow paths as is known in the art.

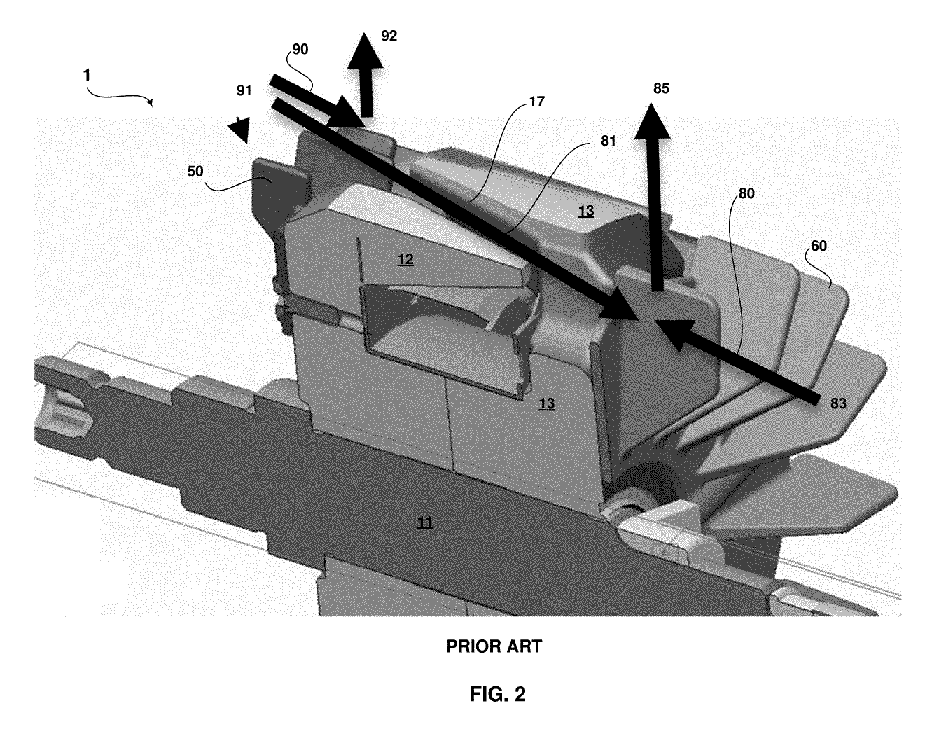

FIG. 3 is a vertical cross-sectional view, taken along the longitudinal axis of a rotor assembly shaft, of an exemplary alternator in accordance with an embodiment of the present invention.

FIG. 4 is a perspective, vertical cross-sectional view, taken along the longitudinal axis of a rotor assembly shaft, of an exemplary alternator in accordance with an embodiment of the present invention.

FIG. 5 is a perspective, vertical cross-sectional view, taken along the longitudinal axis of a rotor assembly shaft, of a portion of an exemplary alternator in accordance with an embodiment of the present invention.

FIG. 6 is a vertical cross-sectional view, taken along the longitudinal axis of a rotor assembly shaft, of an exemplary alternator and exemplary air flows in accordance with an embodiment of the present invention.

FIG. 7 is a rear side perspective view of a first embodiment of an exemplary rear end alternator internal dual-sided fan in accordance with an embodiment of the present invention.

FIG. 8 is a cross-sectional view of a drive end side of a first embodiment of an exemplary rear end alternator internal dual-sided fan in accordance with an embodiment of the present invention.

FIG. 9 is a cross-sectional view of a rear end side of a first embodiment of an exemplary rear end alternator internal dual-sided fan in accordance with an embodiment of the present invention.

FIG. 10 is a side elevation view of a first embodiment of an exemplary rear end alternator internal dual-sided fan in accordance with an embodiment of the present invention.

FIG. 11 is a perspective, vertical cross-sectional view of a portion of a first embodiment of an exemplary rear end alternator internal dual-sided fan in accordance with an embodiment of the present invention.

FIG. 12 is a perspective, vertical cross-sectional view, taken along the longitudinal axis of a rotor assembly shaft, of a portion of an exemplary alternator having a first embodiment of an exemplary rear end alternator internal dual-sided fan and exemplary air flows in accordance with an embodiment of the present invention.

FIG. 13 is a vertical cross-sectional view, taken along the longitudinal axis of a rotor assembly shaft, of an exemplary alternator having a first embodiment of an exemplary rear end alternator internal dual-sided fan and exemplary air flows in accordance with an embodiment of the present invention.

FIG. 14 is a perspective, vertical cross-sectional view, taken along the longitudinal axis of a rotor assembly shaft, of a portion of an exemplary alternator having a first embodiment of an exemplary rear end alternator internal dual-sided fan and exemplary air flows in accordance with an embodiment of the present invention.

FIG. 15 is a rear side perspective view of a second embodiment of an exemplary rear end alternator internal dual-sided fan in accordance with an embodiment of the present invention.

FIG. 16 is a cross-sectional view of a drive end side of a second embodiment of an exemplary rear end alternator internal dual-sided fan in accordance with an embodiment of the present invention.

FIG. 17 is a cross-sectional view of a rear end side of a second embodiment of an exemplary rear end alternator internal dual-sided fan in accordance with an embodiment of the present invention.

FIG. 18 is a side elevation view of a second embodiment of an exemplary rear end alternator internal dual-sided fan in accordance with an embodiment of the present invention.

FIG. 19 is a perspective, vertical cross-sectional view, taken along the longitudinal axis of a rotor assembly shaft, of a portion of an exemplary alternator having a second embodiment of an exemplary rear end alternator internal dual-sided fan and exemplary air flows in accordance with an embodiment of the present invention.

FIG. 20 is a flow diagram that illustrates exemplary steps for cooling electronics and a rear end of stator windings in an alternator in accordance with an embodiment of the present invention.

### DETAILED DESCRIPTION

Certain embodiments of the invention may be found in systems 160, 200, 300 and methods 400 for cooling electronics 130, 140 and a rear end 122 of stator windings 120 in an alternator 100. More specifically, certain embodiments provide a rear end alternator internal dual-sided fan 160, 200, 300 having a rear end blade set 220, 320 that pulls air from a rear end of an alternator 100 to cool electronics 130, 140 in the alternator 100, and a drive end blade set 210, 310 that pulls air from a drive end of the alternator 100 to cool a rear end 122 of stator windings 120 in the alternator 100.

As used herein, the terms “exemplary” and “example” mean serving as a non-limiting example, instance, or illustration. As used herein, the term “e.g.” introduces a list of one or more non-limiting examples, instances, or illustrations.

As used herein, an element recited in the singular and proceeded with the word “a” or “an” should be understood as not excluding the plural of the elements, unless such exclusion is explicitly stated. Furthermore, references to “an embodiment,” “one embodiment,” “a representative embodiment,” “an exemplary embodiment,” “various embodiments,” “certain embodiments,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Although certain embodiments in the foregoing description may be shown with brushless alternators, for example, unless so claimed, the scope of various aspects of the present invention should not be limited to brushless alternators and may additionally and/or alternatively be applicable to brush-type alternators, or any suitable alternator.

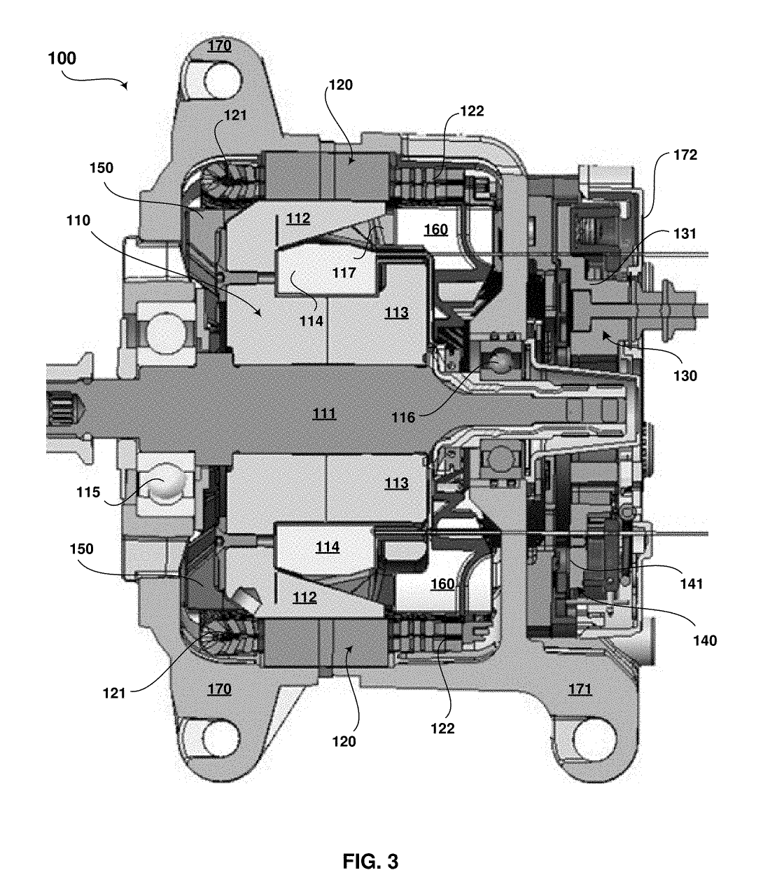

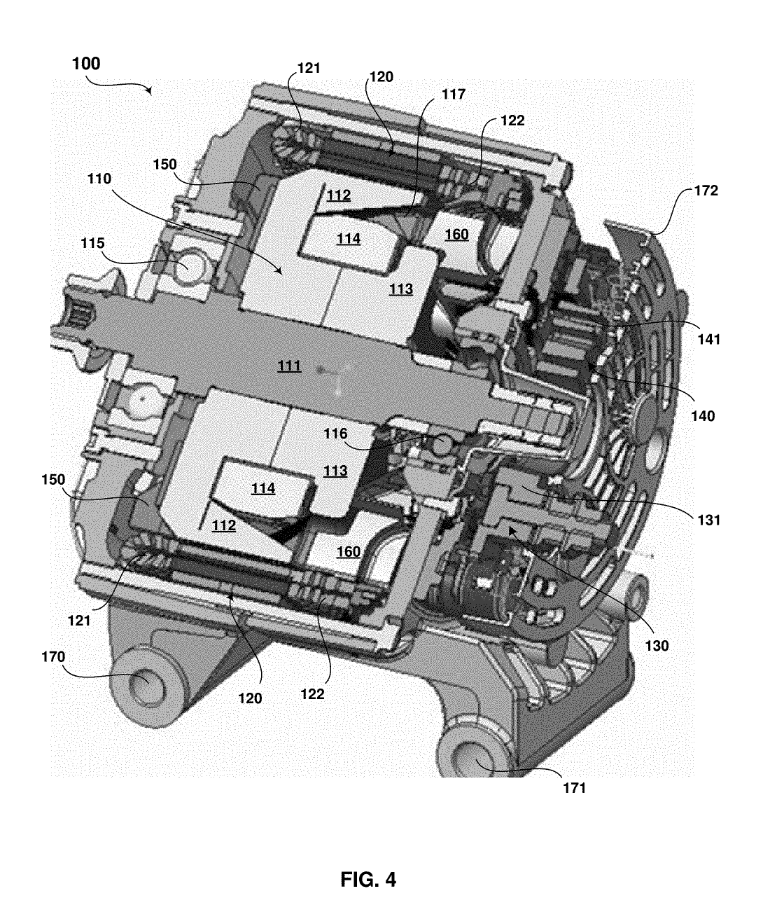

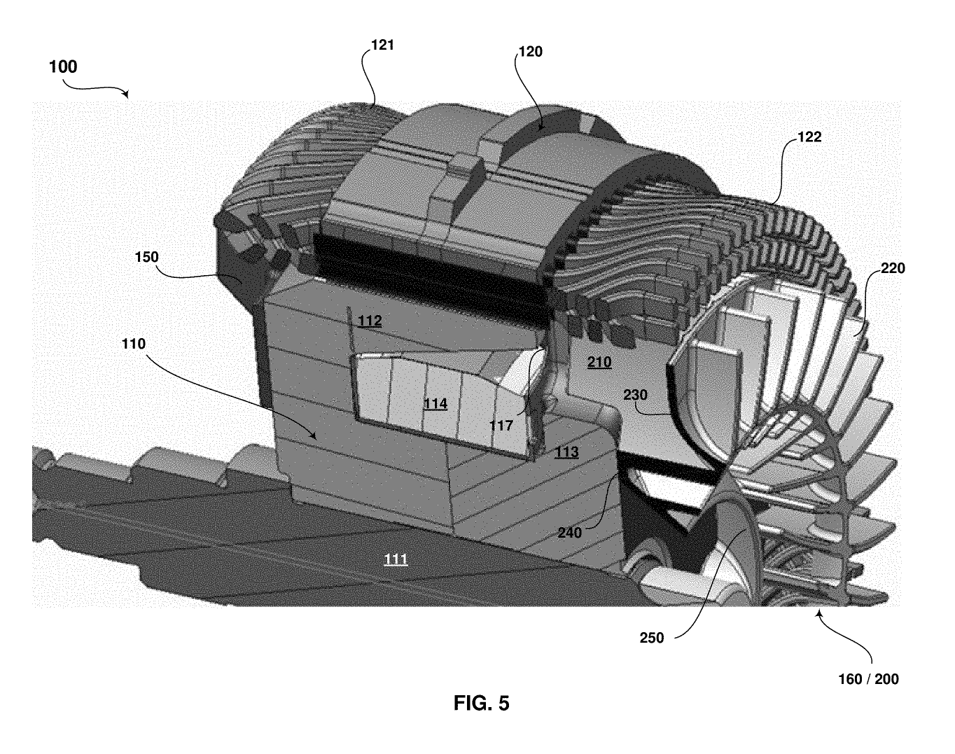

FIG. 3 is a vertical cross-sectional view, taken along the longitudinal axis of a rotor assembly shaft 111, of an exemplary alternator 100 in accordance with an embodiment of the present invention. FIG. 4 is a perspective, vertical cross-sectional view, taken along the longitudinal axis of a rotor assembly shaft 111, of an exemplary alternator 100 in accordance with an embodiment of the present invention. FIG. 5 is a perspective, vertical cross-sectional view, taken along the longitudinal axis of a rotor assembly shaft 111, of a portion of an exemplary alternator 100 in accordance with an embodiment of the present invention. Referring to FIGS. 3-5, the exemplary alternator 100 may comprise a rotor assembly 110, a stator assembly 120, a rectifier assembly 130, a regulator 140, a drive end fan 150, and a rear end dual-sided fan 160, among other things. The components of the alternator 100 may be disposed in a drive end housing 170, a rear end housing 171, and/or a cover assembly 172.

The rotor assembly 110 may comprise a rotor shaft 111, drive end rotor poles 112, rear end rotor poles 113, a field coil 114, drive end bearings 115, and rear end bearings 116, among other things. The rotor shaft 111 may be connected with, for instance, a pulley that may be driven by the engine of a motor vehicle, not shown. The rotor shaft 111 rotates to spin the drive end rotor poles 112 and rear end rotor poles 113 surrounding the stationary field coil 114 to provide an alternating magnetic field that induces an alternating voltage at the stator assembly 120. For example, the rotor poles 112, 113 can be a claw-pole configuration having a number of alternating pole fingers that provides a circumferential surface facing the stator assembly 120. The pole fingers may alternate between a drive end pole 112 and a rear end pole 113. In various embodiments, an air gap 117 may be provided between the drive end pole 112 and rear end pole 113 along the length of the rotor assembly 110. The drive end bearings 115 may support the rotor assembly 110 at the drive end housing 170 and the rear end bearings 116 may support the rotor assembly 110 at the rear end housing 171.

The stator assembly 120 is a stationary component surrounding the rotor assembly 110 and may comprise front end windings 121 and rear end windings 122. The drive end rotor poles 112, rear end rotor poles 113, and field coil 114 of the rotor assembly 110 induce an alternating voltage into the stator windings 121, 122 of the stator assembly 120. The regulator assembly 140 may be disposed in the cover assembly 172 and controls the alternator 100 output by monitoring the battery (not shown) and stator assembly 120 voltages. The regulator 140 adjusts the amount of rotor field current to control the alternator 100 output based on the measured voltages. The rectifier assembly 130 may be disposed in the cover assembly 172 and converts the AC voltage provided by the stator assembly 120 to a DC voltage outputted to a battery, not shown. The rectifier 130 and regulator 140 assemblies may comprise heat sinks 131, 141 for transferring heat generated by the assemblies 130, 140 to ambient temperature air pulled into the alternator 100 by the rear end dual-sided fan 160.

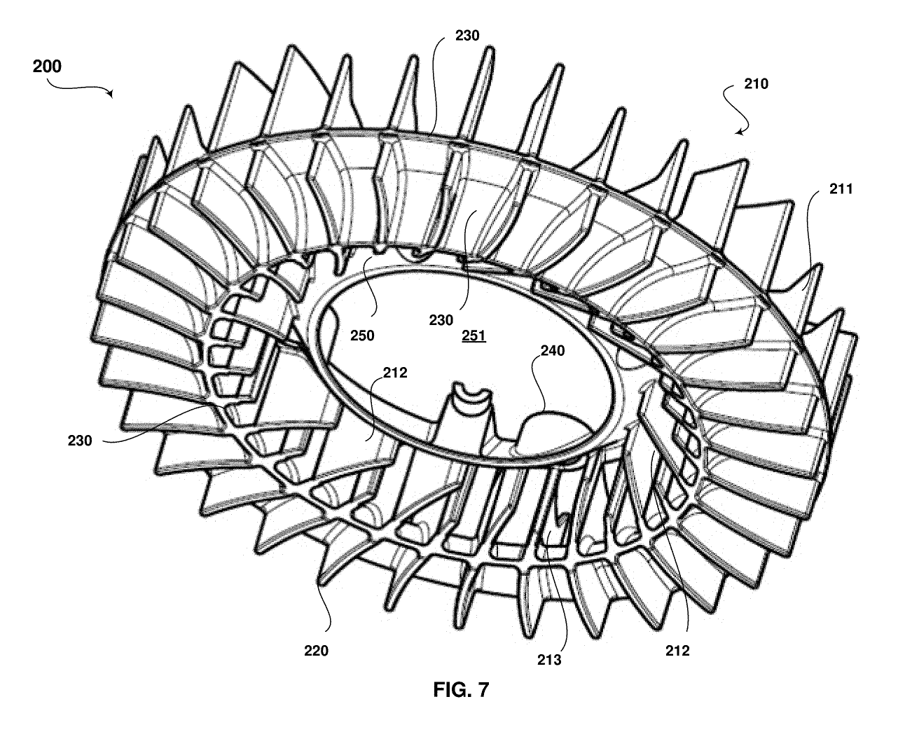

The rear end dual-sided fan 160 may be disposed within the rear end housing 171 and coupled to the rear end poles 113 of the rotor assembly 110. Accordingly, the rear end dual-sided fan 160 may rotate with the spinning of the rear end poles 113. As described in more detail below with reference to FIGS. 7-11 and 15-18, for example, the rear end dual-sided fan 160, 200, 300 may comprise a drive end blade set 210, 310 and a rear end blade set 220, 320 on opposite sides of a separating wall 230, 330. The drive end blade set 210, 310 may be on a first side of the separating wall 230, 330 and generally facing a drive end of the alternator 100, and the rear end blade set 220, 320 may be on a second side of the separating wall 230, 330 and generally facing the rear end of the alternator 100.

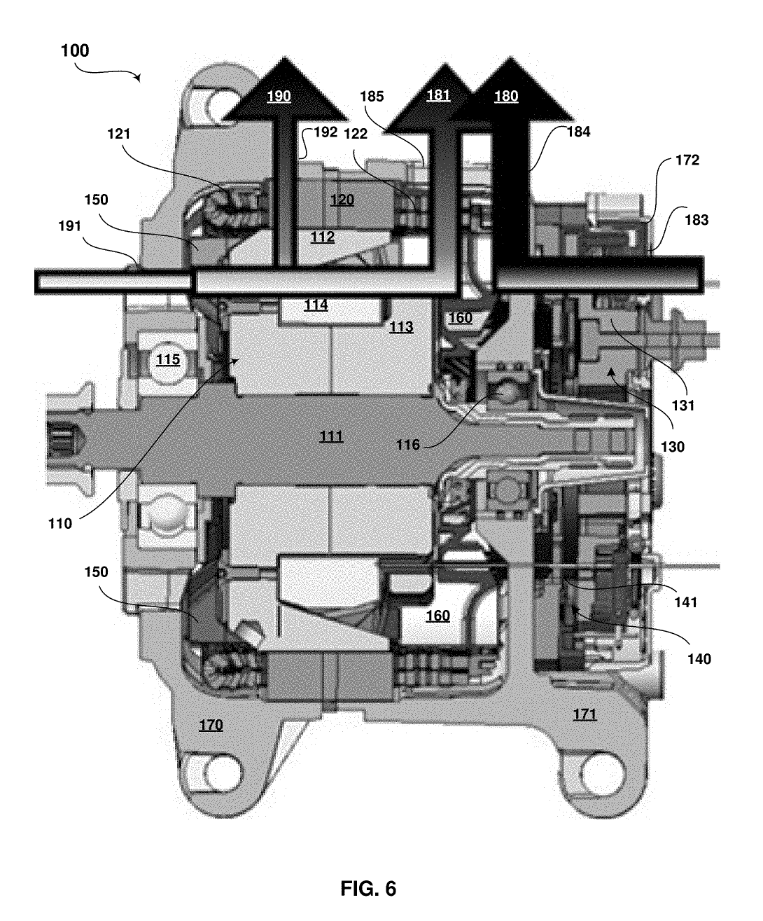

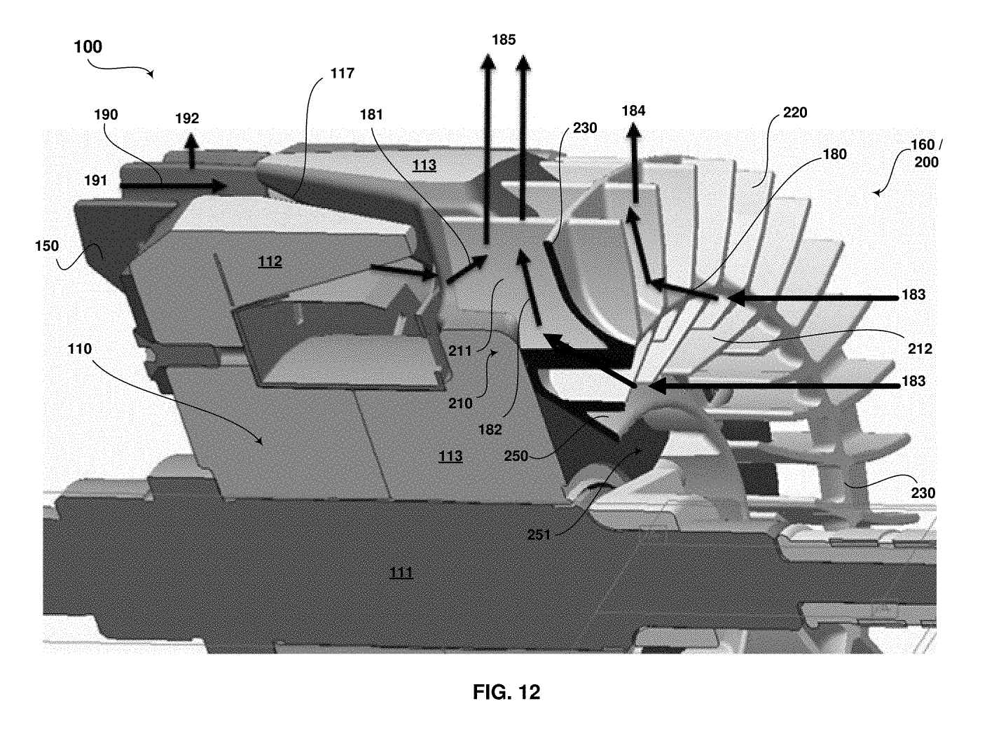

As described in more detail below with reference to FIGS. 6, 12-14, and 19, the rear end blade set 220, 320 of the rear end dual-sided fan 160, 200, 300 may provide a first rear end fan air flow 180 that cools the electronics 130, 140 and is expelled out the side of the alternator 100 to a rear end side of the rear end stator windings 122. In various embodiments, the air flow 180 used primarily to cool the electronics 130, 140 is expelled without passing over the rear end of the stator windings 122. Moreover, the drive end blade set 210, 310 of the rear end dual-sided fan 160, 200, 300 may provide a second rear end fan air flow 181 that pulls air from a drive end of the alternator and expels the air over the rear end stator windings 122 to cool the rear end stator windings 122. In various embodiments, as described in FIGS. 12-14, for example, a portion of the air from the rear end of the alternator may form a third rear end air flow 182 that is combined with the air flow 181 from the drive end to increase the air flow over the rear stator windings 122 without substantially warming the air flow 181 from the drive end. Accordingly, the rear end dual-sided fan 160, 200, 300 provides cooling of the electronics 130, 140 while improving the cooling of the rear stator windings 122 by expelling a majority of the hot electronics heated air flow 180 out of the alternator 100 without passing over the rear stator windings 122, and expelling the cooler drive end air over the rear stator windings 122.

The drive end fan 150 may be disposed within the drive end housing 170 and coupled to the drive end poles 112 of the rotor assembly 110. The drive end fan 150 may therefore rotate with the spinning of the drive end poles 112. As described in more detail below with reference to FIGS. 6, 12-14 and 19, for example, the drive end fan 150 provides a drive end air flow 190 that pulls air from the drive end and expels the air over the front end stator windings 121 of the stator assembly 120 to cool the front end stator windings 121.

FIG. 6 is a vertical cross-sectional view, taken along the longitudinal axis of a rotor assembly shaft 111, of an exemplary alternator 100 and exemplary air flows 180, 181, 190 in accordance with an embodiment of the present invention. Referring to FIG. 6, the exemplary alternator 100 may comprise a rotor assembly 110, a stator assembly 120, a rectifier assembly 130, a regulator 140, a drive end fan 150, and a rear end dual-sided fan 160, among other things. The components of the alternator 100 may be disposed in a drive end housing 170, a rear end housing 171, and/or a cover assembly 172. The rotor assembly 110 may comprise a rotor shaft 111, drive end rotor poles 112, rear end rotor poles 113, a field coil 114, drive end bearings 115, and rear end bearings 116, among other things. The stator assembly 120 is a stationary component surrounding the rotor assembly 110 and may comprise front end windings 121 and rear end windings 122. The regulator assembly 140 controls the alternator 100 output by monitoring the battery (not shown) and stator assembly 120 voltages. The rectifier assembly 130 converts the AC voltage provided by the stator assembly 120 to a DC voltage outputted to a battery, not shown. The rectifier 130 and regulator 140 assemblies may comprise heat sinks 131, 141 for transferring heat generated by the assemblies 130, 140 to ambient temperature air pulled into the alternator 100 by the rear end dual-sided fan 160.

The drive end fan 150 may rotate with the turning of the drive end poles 112 to provide a drive end air flow 190 that pulls air from a drive end air inlet 191 and expels the air over the front end stator windings 121 of the stator assembly 120 at a drive end air outlet 192 to cool the front end stator windings 121.

The rear end dual-sided fan 160 may rotate with the turning of the rear end poles 113 to provide at least a first rear end fan air flow 180 and a second rear end fan air flow 181. For example, the rear end dual-sided fan 160, 200, 300 may comprise a rear end blade set 220, 320 facing the rear end of the alternator 100. The rear end blade set 220, 320 may generate the first rear end fan air flow 180 that: (1) enters the alternator at a rear end air inlet 183, (2) is pulled over a rectifier assembly 130 and/or a regulator 140, and (3) is expelled out the side of the alternator 100 at a first rear end fan air outlet 184 to a rear end side of the rear end stator windings 122. As an example, the first rear end fan air flow 180 may be pulled over the rectifier heat sinks 131 and the regulator heat sinks 141 to transfer the heat from the rectifier assembly 130 and regulator 140 to the first rear end fan air flow 180. Accordingly, the first rear end fan air flow 180 may cool the electronics, such as the rectifier assembly 130, regulator 140, and the like. In various embodiments, the first rear end fan air flow 180 is expelled without passing over the rear end stator windings 122. By directing at least the majority of the hot electronics heated air away from the stator assembly 120, the effectiveness of other air flows cooling the rear end stator windings 122 may be increased, such as the cooling of the rear end stator windings 122 by the second rear end fan air flow 181 described below.

The rear end dual-sided fan 160, 200, 300 may comprise a drive end blade set 210, 310 that at least generally faces the drive end of the alternator 100. The drive end blade set 210, 310 may provide the second rear end fan air flow 181 that enters the alternator at a drive end air inlet 191. The second rear end fan air flow 181 that enters the drive end air inlet 191 may be pulled through an air gap 117 in the rotor assembly 110 of the alternator. The second rear end fan air flow 181 may then be blown over the rear end stator windings 122 of the stator assembly. The second rear end fan air flow 181 blown over the rear end stator windings 122 may be expelled out the side of the alternator 100 at a second rear end fan air outlet 185 at the rear end stator windings 122. Accordingly, the second rear end fan air flow 181 generated by the drive end blade set 210, 310 of the rear end dual-sided fan 160, 200, 300 may cool the rear end stator windings 122 of the stator assembly. The rear end dual-sided fan 160, 200, 300 thereby improves the cooling of the rear stator windings 122 by expelling a majority of the hot electronics heated air flow 180 out of the alternator 100 without passing over the rear stator windings 122 and expelling the cooler drive end air over the rear stator windings 122.

The exemplary alternator 100 illustrated in FIG. 6 shares various characteristics with the exemplary alternator 100 illustrated in FIGS. 3-5 as described above.

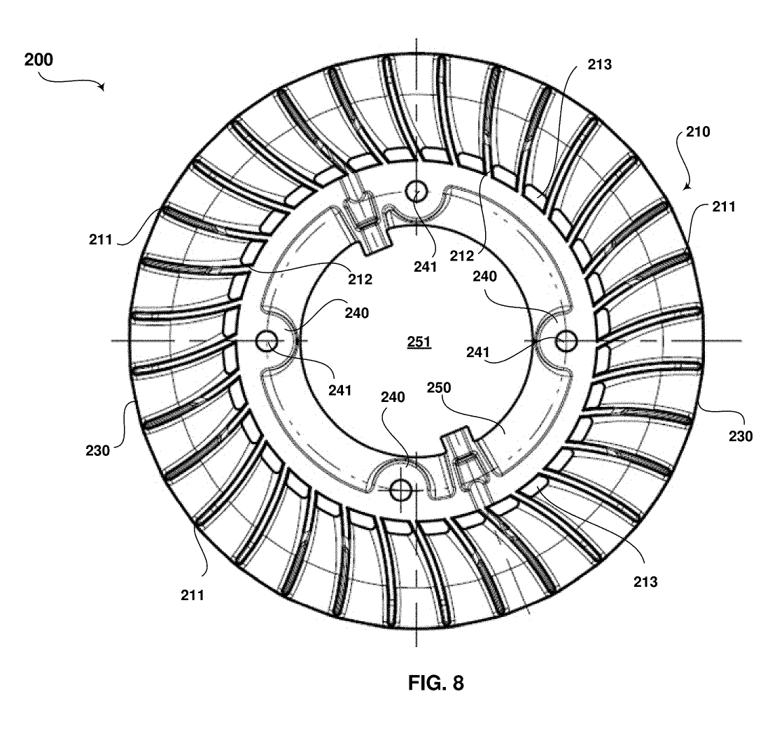

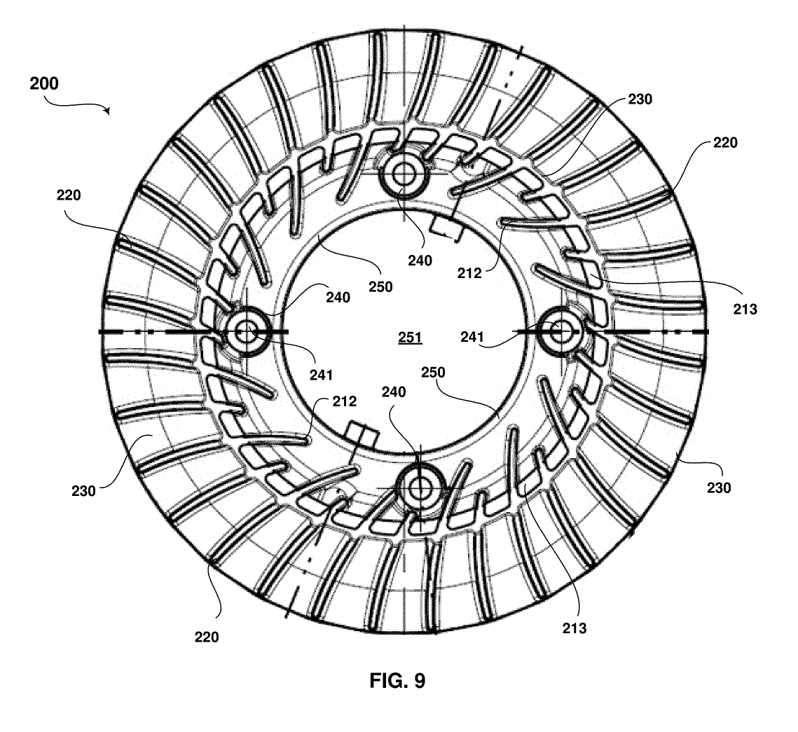

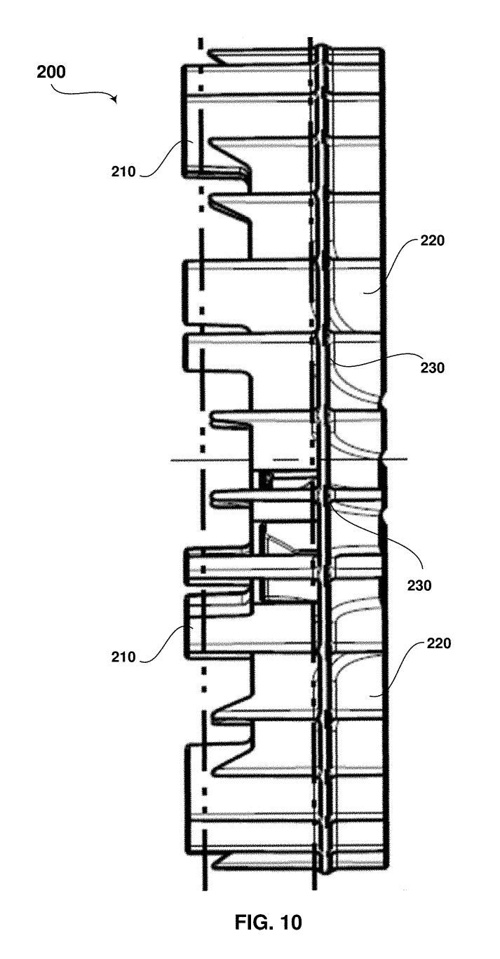

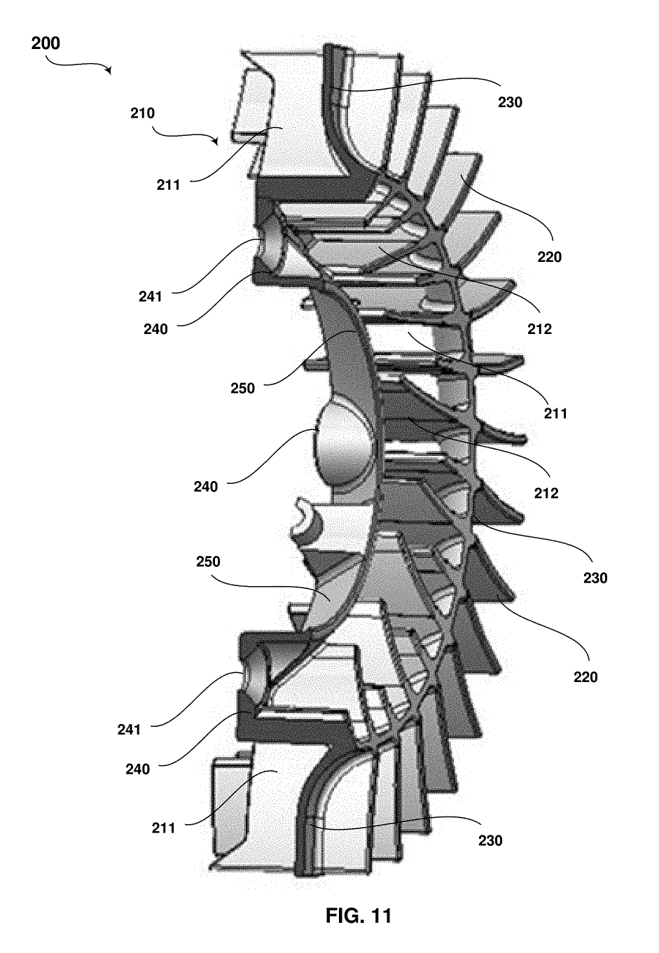

FIG. 7 is a rear side perspective view of a first embodiment of an exemplary rear end alternator internal dual-sided fan 200 in accordance with an embodiment of the present invention. FIG. 8 is a cross-sectional view of a drive end side of a first embodiment of an exemplary rear end alternator internal dual-sided fan 200 in accordance with an embodiment of the present invention. FIG. 9 is a cross-sectional view of a rear end side of a first embodiment of an exemplary rear end alternator internal dual-sided fan 200 in accordance with an embodiment of the present invention. FIG. 10 is a side elevation view of a first embodiment of an exemplary rear end alternator internal dual-sided fan 200 in accordance with an embodiment of the present invention. FIG. 11 is a perspective, vertical cross-sectional view of a portion of a first embodiment of an exemplary rear end alternator internal dual-sided fan 200 in accordance with an embodiment of the present invention.

Referring to FIGS. 7-11, the rear end alternator internal dual-sided fan 200 comprises a drive end blade set 210, a rear end blade set 220, a separating wall 230, a mounting wall 240, and an air deflecting wall 250, among other things. The drive end blade set 210 and the rear end blade set 220 are provided on opposite sides of a curved separating wall 230. For example, the separating wall 230 may curve toward a rear end of an alternator 100 if the rear end dual-sided fan 200 is mounted to a rear end pole 113 of a rotor assembly 110 of the alternator 100. The dual-sided fan 200 may be a centrifugal fan configured to accelerate air radially out along the separating wall 230 and between the blade sets 210, 220 on both sides of the separating wall 230. The blade sets 210, 220 may include straight, curved backward, curved forward, or any suitable blade shape or combination of blade shapes. In various embodiments, the length of the blades in the blade sets 210, 220 may be constant, variable, and/or alternating lengths. In a representative embodiment, the blades may extend toward a drive end and/or toward a rear end of an alternator 100 from the separating wall 230 (i.e., a depth) at constant, variable, and/or alternating depths. For example, the depth of the blades in the drive end blade set 210 may be configured to extend at least partially around and/or in between the rotor poles 112, 113 of the rotor assembly 110. As another example, the blades in the drive end blade set 210 may be notched to extend at least partially around and/or in between the rotor poles 112, 113.

The drive end blade set 210 may comprise an outer portion 211 and an inner portion 212. The outer portion 211 of the drive end blade set 210 may be configured to generally face a drive end of an alternator 100 if the rear end dual-sided fan 200 is mounted to a rear end pole 113 of a rotor assembly 110 of the alternator 100. As described below in reference to FIGS. 12-14, for example, the outer portion 211 of the drive end blade set 210 may generate the second rear end fan air flow 181. The inner portion 212 of the drive end blade set 210 may wrap around the separating wall 230 to generally face the center opening 251 of the rear dual-sided fan 200.

The air deflecting wall 250 may be a substantially circular wall defining a center opening 251 in the rear dual-sided fan 200. In various embodiments, a rotor shaft 211 may extend through the center opening 251 if the rear dual-sided fan 200 is mounted to the rotor assembly 110 in an alternator 100. The air deflecting wall 250 may be coupled to a portion of the inner portion 212 of the drive end blade set 210 and may be configured to deflect air pulled by the inner portion 212 drive end blades from the rear end side of the dual-sided fan 200 through an air gap 213 between the air deflecting wall 250 and the separating wall 230. As described below in reference to FIGS. 12-14, for example, the inner portion 212 of the drive end blade set 210 may generate the third rear end fan air flow 182 that is combined with the second rear end air flow 181 at the drive end side of the rear dual-sided fan 200 and expelled at the second rear end fan air outlet 185 over the rear end stator windings 122 of the alternator 100.

The mounting wall 240 may extend from the air deflecting wall 250 and may be configured to couple with a rear end pole 113 of a rotor assembly 110 of an alternator 100. For example, the mounting wall 240 may be welded, screwed, riveted, or the like to the rear end pole 113. In various embodiments, the mounting wall 240 may comprise mounting holes 241 for receiving an attachment mechanism, such as a screw or the like, for mounting the mounting wall 240 of the dual-sided fan 200 to the rear end pole 113 of the rotor assembly 110.

Still referring to FIGS. 7-11, the rear end blade set 220 may be configured to face a rear end of an alternator 100 if the rear end dual-sided fan 200 is mounted to a rear end pole 113 of a rotor assembly 110 of the alternator 100. As described below in reference to FIGS. 12-14, for example, the rear end blade set 220 may generate the first rear end fan air flow 180 that may be pulled over electronics 130, 140 of an alternator 100 and expelled on a rear end side of the rear end stator windings 122 of the alternator 100.

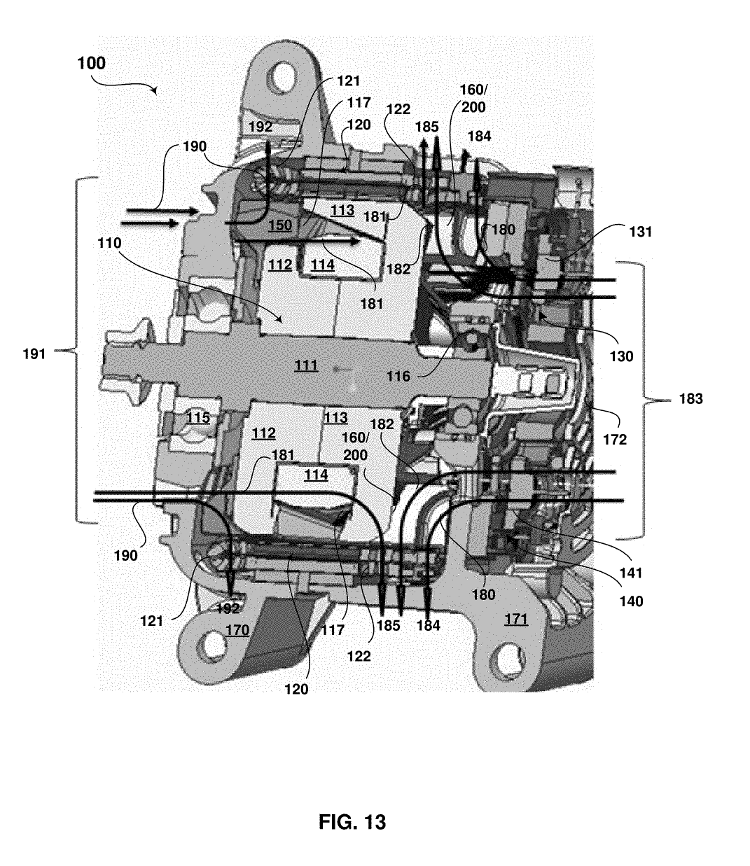

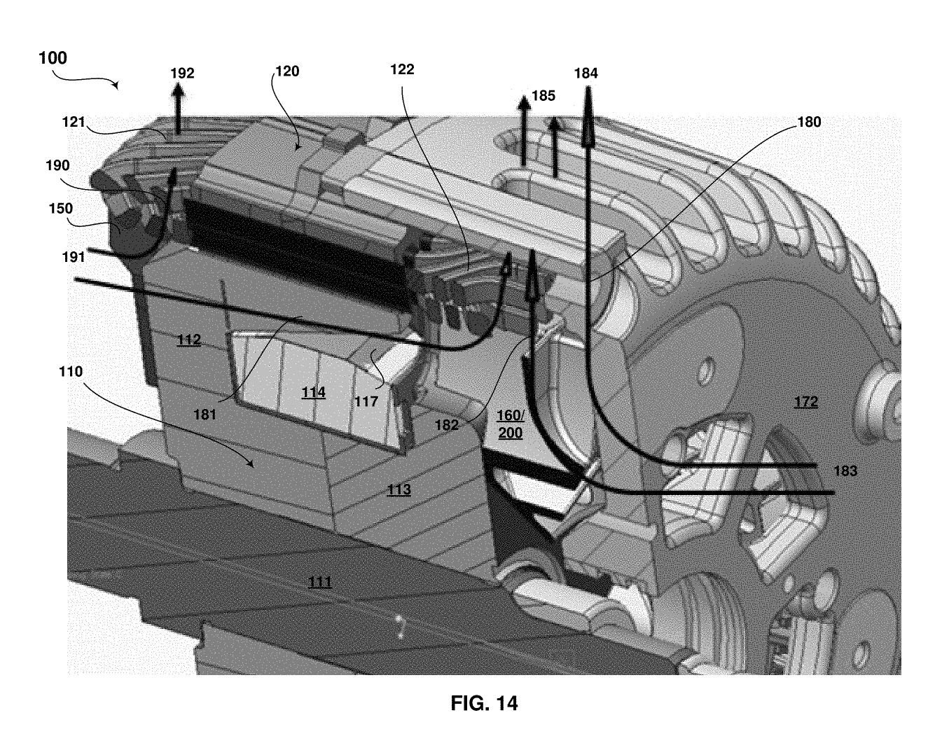

FIG. 12 is a perspective, vertical cross-sectional view, taken along the longitudinal axis of a rotor assembly shaft 111, of a portion of an exemplary alternator 100 having a first embodiment of an exemplary rear end alternator internal dual-sided fan 200 and exemplary air flow paths 180, 181, 182, 190 in accordance with an embodiment of the present invention. FIG. 13 is a vertical cross-sectional view, taken along the longitudinal axis of a rotor assembly shaft, of an exemplary alternator having a first embodiment of an exemplary rear end alternator internal dual-sided fan and exemplary air flow paths in accordance with an embodiment of the present invention. FIG. 14 is a perspective, vertical cross-sectional view, taken along the longitudinal axis of a rotor assembly shaft, of a portion of an exemplary alternator having a first embodiment of an exemplary rear end alternator internal dual-sided fan and exemplary air flow paths in accordance with an embodiment of the present invention.

Referring to FIGS. 12-14, the exemplary alternator 100 may comprise a rotor assembly 110, a stator assembly 120, a rectifier assembly 130, a regulator 140, a drive end fan 150, and a rear end dual-sided fan 160, among other things. The components of the alternator 100 may be disposed in a drive end housing 170, a rear end housing 171, and/or a cover assembly 172. The rotor assembly 110 may comprise a rotor shaft 111, drive end rotor poles 112, rear end rotor poles 113, a field coil 114, drive end bearings 115, and rear end bearings 116, among other things. The stator assembly 120 is a stationary component surrounding the rotor assembly 110 and may comprise front end windings 121 and rear end windings 122. The regulator assembly 140 controls the alternator 100 output by monitoring the battery (not shown) and stator assembly 120 voltages. The rectifier assembly 130 converts the AC voltage provided by the stator assembly 120 to a DC voltage outputted to a battery, not shown. The rectifier 130 and regulator 140 assemblies may comprise heat sinks 131, 141 for transferring heat generated by the assemblies 130, 140 to ambient temperature air pulled into the alternator 100 by the rear end dual-sided fan 160.

The drive end fan 150 may rotate with the turning of the drive end poles 112 to provide a drive end air flow 190 that pulls air from a drive end air inlet 191 and expels the air over the front end stator windings 121 of the stator assembly 120 at a drive end air outlet 192 to cool the front end stator windings 121.

The rear end dual-sided fan 160 may be the rear end dual-sided fan 200 as described above with reference to FIGS. 7-11, for example. The dual-sided fan 160, 200 may rotate with the turning of the rear end poles 113 to provide a first rear end fan air flow 180, a second rear end fan air flow 181, and a third rear end air flow 182. For example, the rear end dual-sided fan 160, 200 may comprise a rear end blade set 220 facing the rear end of the alternator 100. The rear end blade set 220 may generate the first rear end fan air flow 180 that: (1) enters the alternator at a rear end air inlet 183, (2) is pulled over a rectifier assembly 130 and/or a regulator 140, and (3) is expelled out the side of the alternator 100 at a first rear end fan air outlet 184 to a rear end side of the rear end stator windings 122. As an example, the first rear end fan air flow 180 may be pulled over the rectifier heat sinks 131 and the regulator heat sinks 141 to transfer the heat from the rectifier assembly 130 and regulator 140 to the first rear end fan air flow 180.

The rear end dual-sided fan 160, 200 may comprise a drive end blade set 210 having an outer portion 211 facing the drive end of the alternator 100 and an inner portion 212 facing a center opening 251 of the dual-sided fan 160, 200. The outer portion 211 of the drive end blade set 210 may provide the second rear end fan air flow 181 that enters the alternator at a drive end air inlet 191. The second rear end fan air flow 181 that enters the drive end air inlet 191 may be pulled through an air gap 117 in the rotor assembly 110 of the alternator 100. The second rear end fan air flow 181 may then be blown over the rear end stator windings 122 of the stator assembly 120. The second rear end fan air flow 181 blown over the rear end stator windings 122 may be expelled out the side of the alternator 100 at a second rear end fan air outlet 185 at the rear end stator windings 122.

The inner portion 212 of the drive end blade set 210 may generate the third rear end fan air flow 182 that enters the alternator at the rear end air inlet 183. The third rear end fan air flow 182 that enters the rear end air inlet 183 may be pulled over a rectifier assembly 130 and/or a regulator 140. The third rear end fan air flow 182 may then be pulled by the inner portion 212 of the drive end blade set 210 between the air deflecting wall 250 and the separating wall 230 through the air gap 213 to the drive end side of the dual-sided fan 160, 200. The third rear end fan air flow 182 may then be combined with the second rear end fan air flow 181 and blown over the rear end stator windings 122 of the stator assembly 120. The mixture of the third rear end fan air flow 182 with the second rear end air flow 181 increases the air flow over the rear stator windings 122 without substantially warming the air flow 181 from the drive end. The third rear end fan air flow 182 blown over the rear end stator windings 122 with the second rear end fan air flow 181 may be expelled out the side of the alternator 100 at a second rear end fan air outlet 185 at the rear end stator windings 122.

The exemplary alternator 100 illustrated in FIGS. 12-14 shares various characteristics with the exemplary alternator 100 illustrated in FIGS. 3-6 as described above.

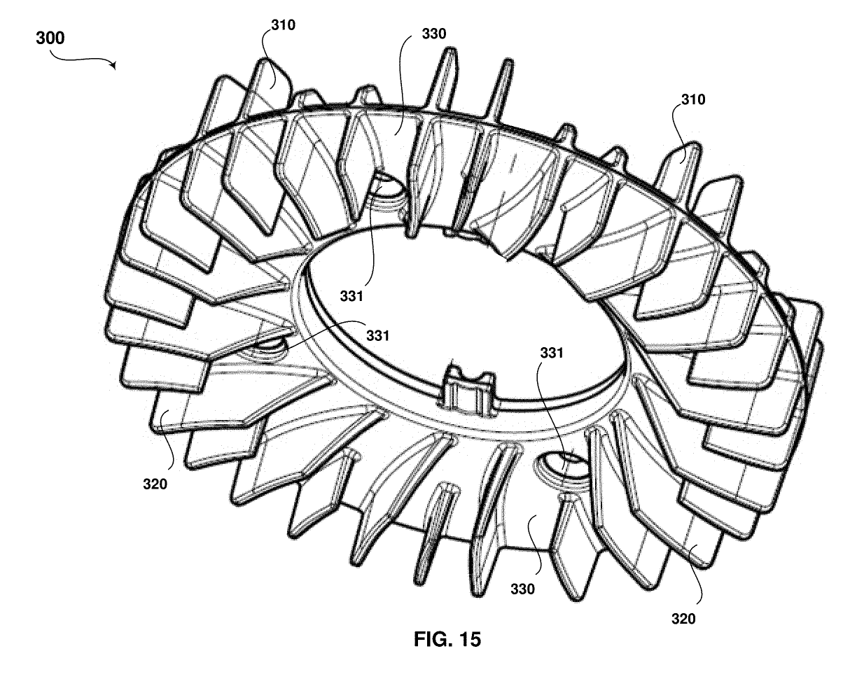

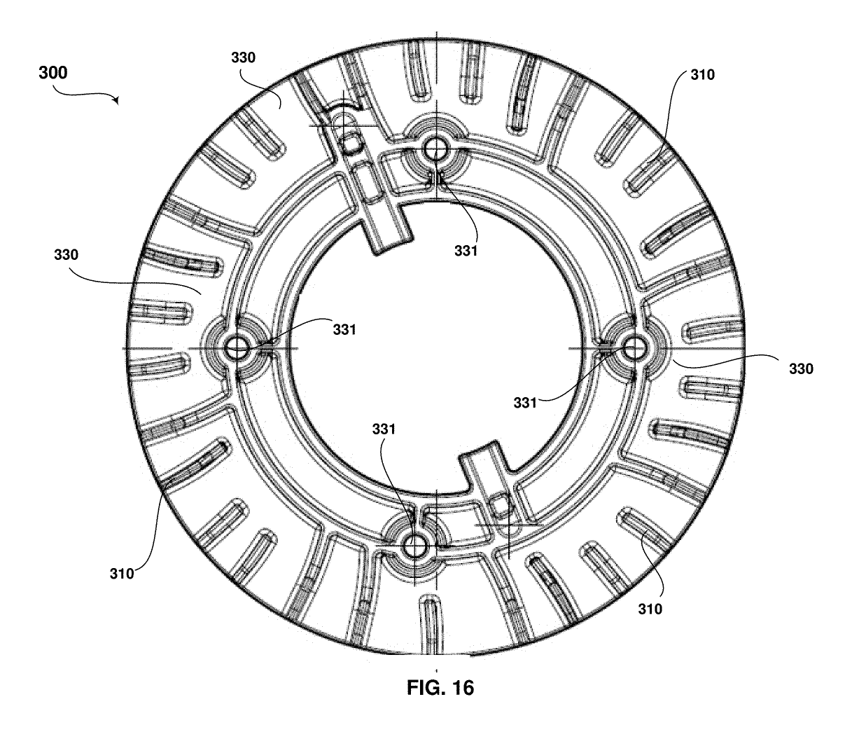

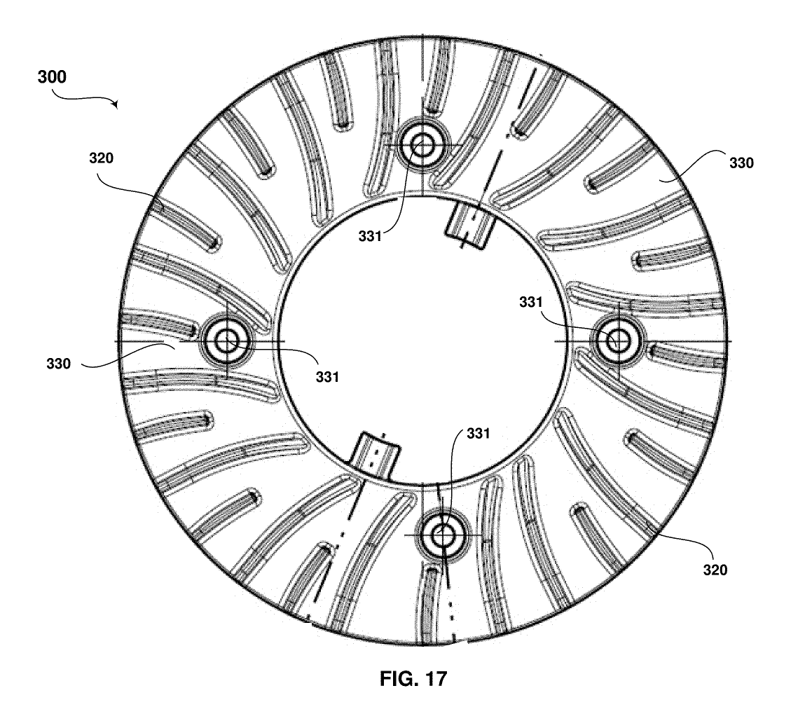

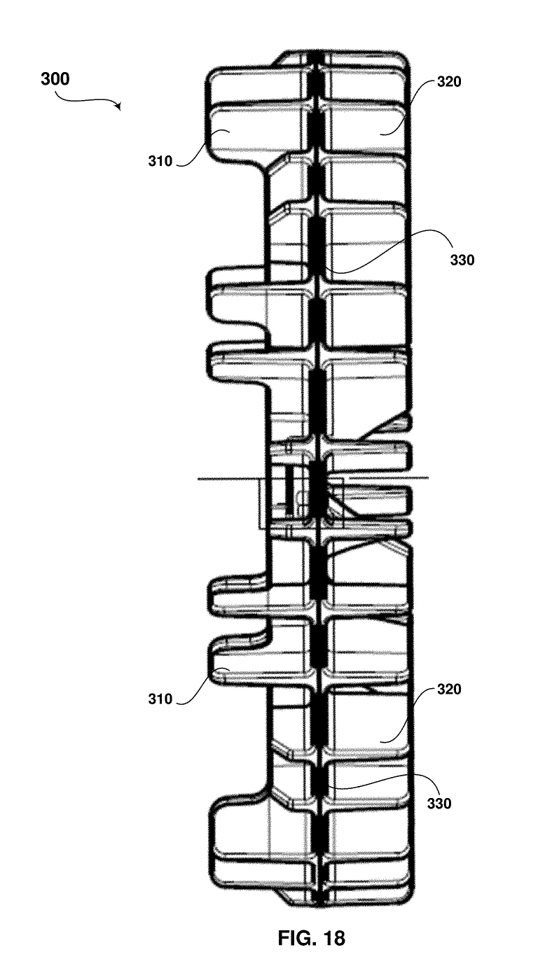

FIG. 15 is a rear side perspective view of a second embodiment of an exemplary rear end alternator internal dual-sided fan 300 in accordance with an embodiment of the present invention. FIG. 16 is a cross-sectional view of a drive end side of a second embodiment of an exemplary rear end alternator internal dual-sided fan 300 in accordance with an embodiment of the present invention. FIG. 17 is a cross-sectional view of a rear end side of a second embodiment of an exemplary rear end alternator internal dual-sided fan 300 in accordance with an embodiment of the present invention. FIG. 18 is a side elevation view of a second embodiment of an exemplary rear end alternator internal dual-sided fan 300 in accordance with an embodiment of the present invention.

Referring to FIGS. 15-18, the rear end alternator internal dual-sided fan 300 comprises a drive end blade set 310, a rear end blade set 320, and a separating wall 330, among other things. The drive end blade set 310 and the rear end blade set 320 are provided on opposite sides of a separating wall 330 and are substantially perpendicular to the separating wall 330. For example, the separating wall 330 may be a generally straight, vertical wall and the drive end blade set 310 and rear end blade set 320 may be mounted to and extend horizontally away from opposite sides of the separating wall 330. The dual-sided fan 300 may be a centrifugal fan configured to accelerate air radially out along the separating wall 330 and between the blade sets 310, 320 on both sides of the separating wall 330. The blade sets 310, 320 may include straight, curved backward, curved forward, or any suitable blade shape or combination of blade shapes. In various embodiments, the length of the blades in the blade sets 310, 320 may be constant, variable, and/or alternating lengths. In a representative embodiment, the blades may extend toward a drive end and/or toward a rear end of an alternator 100 from the separating wall 330 (i.e., a depth) at constant, variable, and/or alternating depths. For example, the depth of the blades in the drive end blade set 310 may be configured to extend at least partially around and/or in between the rotor poles 112, 113 of the rotor assembly 110. As another example, the blades in the drive end blade set 310 may be notched to extend at least partially around and/or in between the rotor poles 112, 113.

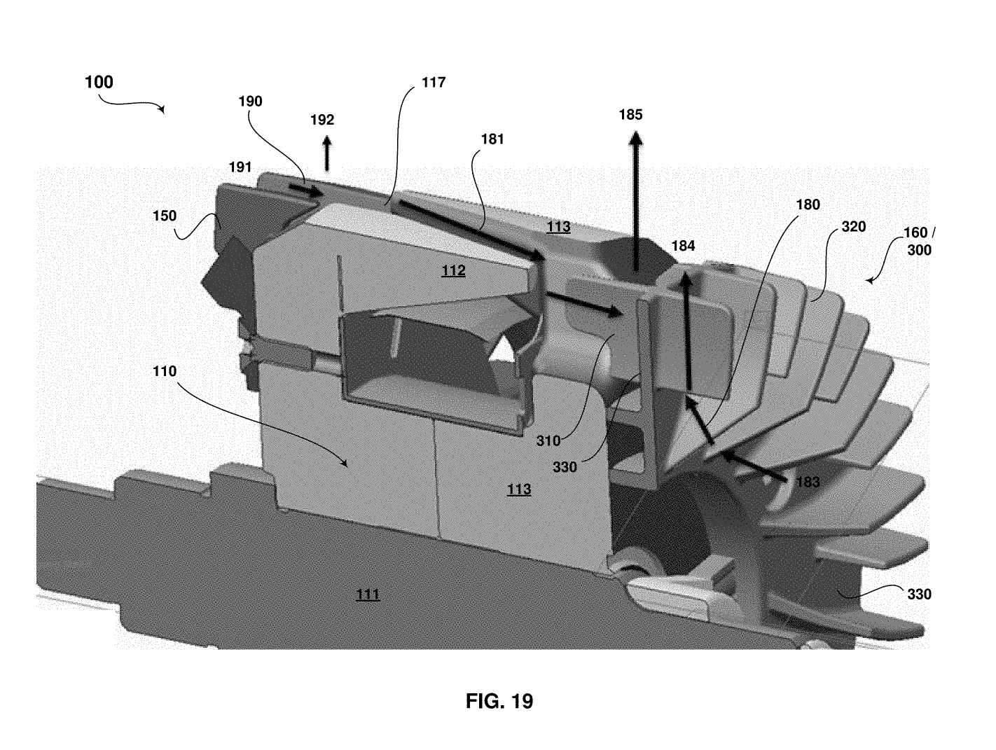

The drive end blade set 310 may be configured to face a drive end of an alternator 100 if the rear end dual-sided fan 300 is mounted to a rear end pole 113 of a rotor assembly 110 of the alternator 100. As described below in reference to FIG. 19, for example, the drive end blade set 310 may generate the second rear end fan air flow 181 that may be blown over the rear end stator windings 122 of the stator assembly 120. The rear end blade set 320 may be configured to face a rear end of an alternator 100 if the rear end dual-sided fan 300 is mounted to a rear end pole 113 of a rotor assembly 110 of the alternator 100. As described below in reference to FIG. 19, for example, the rear end blade set 320 may generate the first rear end fan air flow 180 that may be pulled over electronics 130, 140 of an alternator 100 and expelled on a rear end side of the rear end stator windings 122 of the alternator 100. The separating wall 330 of the rear end dual-sided fan 300 may mount to a rear end pole 113 of a rotor assembly 110 of the alternator 100. For example, the separating wall 330 may be welded, screwed, riveted, or the like to the rear end pole 113. In various embodiments, the separating wall 330 may comprise mounting holes 331 for receiving an attachment mechanism, such as a screw or the like, for mounting the separating wall 330 of the dual-sided fan 300 to the rear end pole 113 of the rotor assembly 110.

FIG. 19 is a perspective, vertical cross-sectional view, taken along the longitudinal axis of a rotor assembly shaft 111, of a portion of an exemplary alternator 100 having a second embodiment of an exemplary rear end alternator internal dual-sided fan 300 and exemplary air flow paths 180, 181, 190 in accordance with an embodiment of the present invention.

Referring to FIG. 19, the exemplary alternator 100 may comprise a rotor assembly 110, a drive end fan 150, and a rear end dual-sided fan 160, among other things. The rotor assembly 110 may comprise a rotor shaft 111, drive end rotor poles 112, and rear end rotor poles 113, among other things. The drive end fan 150 may rotate with the turning of the drive end poles 112 to provide a drive end air flow 190 that pulls air from a drive end air inlet 191 and expels the air over the front end stator windings at a drive end air outlet 192 to cool the front end stator windings, not shown.

The rear end dual-sided fan 160 may be the rear end dual-sided fan 300 as described above with reference to FIGS. 15-18, for example. The dual-sided fan 160, 300 may rotate with the turning of the rear end poles 113 to provide a first rear end fan air flow 180 and a second rear end fan air flow 181. For example, the rear end dual-sided fan 160, 300 may comprise a rear end blade set 320 facing the rear end of the alternator 100. The rear end blade set 320 may generate the first rear end fan air flow 180 that: (1) enters the alternator at a rear end air inlet 183, (2) is pulled over electronic components of the alternator 100, and (3) is expelled out the side of the alternator 100 at a first rear end fan air outlet 184 to a rear end side of rear end stator winding, not shown.

The rear end dual-sided fan 160, 300 may comprise a drive end blade set 310 facing the drive end of the alternator 100. The drive end blade set 310 may provide the second rear end fan air flow 181 that enters the alternator at a drive end air inlet 191. The second rear end fan air flow 181 that enters the drive end air inlet 191 may be pulled through an air gap 117 in the rotor assembly 110 of the alternator 100. The second rear end fan air flow 181 may then be blown over the rear end stator windings of the stator assembly, not shown. The second rear end fan air flow 181 may be expelled out the side of the alternator 100 at a second rear end fan air outlet 185 at the rear end stator windings, not shown.

The exemplary alternator 100 illustrated in FIG. 19 shares various characteristics with the exemplary alternator 100 illustrated in FIGS. 3-6 as described above.

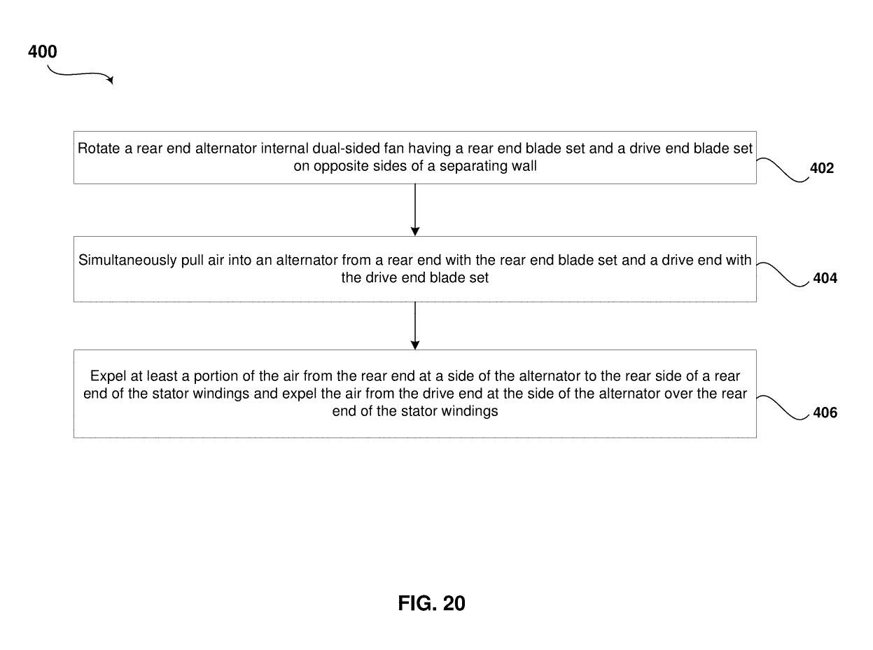

FIG. 20 is a flow diagram 400 that illustrates exemplary steps 402-406 for cooling electronics 130, 140 and a rear end of stator windings 122 in an alternator 100 in accordance with an embodiment of the present invention. Referring to FIG. 20, there is shown a flow chart 400 comprising exemplary steps 402 through 406. Certain embodiments of the present invention may omit one or more of the steps, and/or perform the steps in a different order than the order listed, and/or combine certain of the steps discussed below. For example, some steps may not be performed in certain embodiments. As a further example, certain steps may be performed in a different temporal order than listed below, including but not limited to simultaneously. Although the method is described with reference to the exemplary elements of the systems described above, it should be understood that other implementations are possible.

At step 402, a rear end alternator internal dual-sided fan 160, 200, 300 is rotated. In certain embodiments, the dual-sided fan 160, 200, 300 may be the fan 200 described with reference to FIGS. 7-14 or the fan 300 described with reference to FIGS. 15-19 above, or any suitable rear dual-sided fan 160. For example, the rear dual-sided fan 160 may comprise a rear end blade set 220, 320 and a drive end blade set 210, 310 on opposite sides of a separating wall 230, 330. The rear dual-sided fan 160, 200, 300 is positioned internally at a rear end of an alternator 100. For example, the rear dual-sided fan 160, 200, 300 may be connected to rear end poles 113 of a rotor assembly 110 of the alternator 100, for rotation with the rear end rotor poles 113. The rear end rotor poles 113 are driven to rotate by a rotor shaft 111 connected with, for instance, a pulley that may be driven by the engine of a motor vehicle, not shown.

At step 404, ambient temperature air is drawn into the alternator 100 at a drive end air inlet 191 by the drive end blade set 210, 310 and at a rear end air inlet 183 by the rear end blade set 220, 320. For example, the rotation of the rear dual-sided fan 160, 200, 300 causes the rear end blade set 220, 320 to pull ambient temperature air into the alternator 100 at a rear end air inlet 183. The air flow 180 generated by the rear end blade set 220, 320 from the rear end air inlet 183 may be pulled over electronics, such as a regulator 140 and/or a rectifier assembly 130. The regulator 140 and rectifier assembly 130 may have heat sinks 141, 131 for transferring heat to the air flow 180, thereby cooling the regulator 140 and rectifier assembly 130. The air flow 181 may then be blown over rear end stator windings 122 of a stator assembly 120 of the alternator 100 to cool the rear end stator windings 122.

Moreover, the rotation of the rear dual-sided fan 160, 200, 300 may cause the drive end blade set 210, 310 to pull ambient temperature air into the alternator 100 at a drive end air inlet 191. The air flow 181 generated by the drive end blade set 210, 310 from the drive end air inlet 191 may be pulled through an air gap 117 in the rotor assembly 110. The air flow 181 may then be blown over rear end stator windings 122 of a stator assembly 120 of the alternator 100 to cool the rear end stator windings 122.

In an exemplary embodiment, the drive end blade set 210 may comprise an outer portion 211 generally facing the drive end of the alternator 100 and an inner portion 212 generally facing a center opening 251 in the rear dual-sided fan 200 as described above with reference to the embodiment of FIGS. 7-14. For example, the separating wall 230 separating the drive end blade set 210 from the rear end blade set 220 may curve toward the rear end of the alternator 100. The portion of the drive end blade set 210 extending from the curved separating wall 230 generally toward the drive end of the alternator 100 is referred to as the outer portion 211 of the drive end blade set 210. The portion of the drive end blade set 210 extending from the curved separating wall 230 generally toward the center opening 251 of the fan 200 is referred to as the inner portion 212 of the drive end blade set 210.

As described above, the outer portion 211 of the drive end blade set 210 may generate the air flow 181 from the drive end inlet 191. The rotation of the rear dual-sided fan 160, 200 may cause an inner portion 212 of the drive end blade set 210 to pull ambient temperature air into the alternator 100 at the rear end air inlet 183. The air flow 182 generated by the inner portion 212 of the drive end blade set 210 from the rear end air inlet 183 may be pulled, with the air flow 180 generated by the rear end blade set 220, over a regulator 140 and/or a rectifier assembly 130 to cool the regulator 140 and rectifier assembly 130. The air flow 182 may then pass through an air gap 213 in the rear dual-sided fan 200 from the rear end side to the drive end side where it is combined with the air flow 181 generated by the outer portion 211 of the drive end blade set 210. The combined air flows 181, 182 generated by the outer portion 211 and inner portion 212 of the drive end blade set 210 may then be blown over rear end stator windings 122 of a stator assembly 120 of the alternator 100 to cool the rear end stator windings 122.

At step 406, the air flow 180 generated by the rear end blade set 220, 320 of the rear dual-sided fan 160, 200, 300 is expelled from sides of the alternator 100 to a rear side, as opposed to over, the rear end stator windings 122 of the stator assembly. The air flow(s) 181, 182 generated by the drive end blade set 210, 210 of the rear dual-sided fan 160, 200, 300 is expelled from sides of the alternator 100 over the rear end stator windings 122 of the stator assembly 120. For example, the air flow 180 generated by the rear end blade set 220, 320 is heated by passing over the electronics 130, 140 to cool the electronics 130, 140. The air flow 181 generated by the drive end blade set 210, 310 is heated by passing over the rear stator windings 122 to cool the rear stator windings 122 of the stator assembly 120. Accordingly, the rear end dual-sided fan 160, 200, 300 provides cooling of the electronics 130, 140 while improving the cooling of the rear stator windings 122 by expelling a majority of the hot electronics heated air flow 180 out of the alternator 100 without passing over the rear stator windings 122, and expelling the cooler drive end air 181 over the rear stator windings 122. In various embodiments, such as the embodiment described above in reference to FIGS. 7-14, the drive end blade set 210 may combine an electronics-warmed air flow 182 with the cooler drive end air flow 181, and the combined air flows 181, 182 may be passed over the rear stator windings 122. In such embodiments, the cooler drive end air flow 181 may be greater than the electronics-warmed air flow 182 such that the electronics-warmed air flow 182 increases the overall air flow 181, 182 over the rear stator windings 122 without substantially warming the cooler drive end air flow 181.

Various embodiments provide an alternator 100 comprising a housing 170, 171, 172, a rotor assembly 110, a stator assembly 120, and a dual-sided fan 160, 200, 300. The housing 170, 171, 172 may comprise a drive end, a rear end, and sides. The rotor assembly may comprise drive end poles 112 and rear end poles 113. The drive end poles 112 and the rear end poles 113 may be disposed within the housing 170, 171, 172. The stator assembly 120 may be disposed within the housing 170, 171, 172 and may surround the drive end poles 112 and the rear end poles 113. The stator assembly 120 may comprise drive end stator windings 121 and rear end stator windings 122. The dual-sided fan 160, 200, 300 may be disposed within the housing 170, 171, 172 and may be mounted to the rotor assembly 110 adjacent to the rear end poles 113. The dual-sided fan 160, 200, 300 may comprise a separating wall 230, 330, a drive end blade set 210, 310, and a rear end blade set 220, 320. The separating wall 230 may comprise a first side and a second side. The drive end blade set 210, 310 may extend from the first side of the separating wall 230, 330 and may at least partially face the drive end. The rear end blade set 220, 320 may extend from the second side of the separating wall 230, 330 and may at least partially face the rear end.

In a representative embodiment, the dual-sided fan 160, 200, 300 is rotatable by the rotor assembly 110. Moreover, if the dual-sided fan 160, 200, 300 is rotated, the rear end blade set 220, 320 draws a first air flow 180 through a rear end air inlet 183 at the rear end of the housing 172 and expels the first air flow 180 out the sides of the housing 170, 171, 172 at a first rear end fan air outlet 184 toward the rear end from the rear end stator windings 122. Furthermore, if the dual-sided fan 160, 200, 300 is rotated, the drive end blade set 210, 310 draws a second air flow 181 through a drive end air inlet 191 at the drive end of the housing 170 and expels the second air flow 181 over the rear end stator windings 122 and out the sides of the housing 170, 171, 172 at a second rear end fan air outlet 185. In various embodiments, at least a portion of the rear end stator windings 122 transfers heat to the second air flow 181.

In certain embodiments, the air 180, 181 drawn through the rear end air inlet 183 and the drive end air inlet 191 is ambient temperature air. In a representative embodiment, electronics 130, 140 are disposed in the housing 170, 171, 172 between the dual-sided fan 160, 200, 300 and the rear end of the housing 172. In various embodiments, if the dual-sided fan 160, 200, 300 is rotated, the rear end blade set 220, 320 draws the first air flow 180 over the electronics 130, 140. In certain embodiments, at least a portion of the electronics 130, 140 transfers heat to the first air flow 180.

In various embodiments, the dual-sided fan 160, 200 comprises a first fan side facing the drive end, a second fan side facing the rear end, an air deflecting wall 250, and an air gap 213 between the air deflecting wall 250 and the separating wall 230. The separating wall 230 is curved toward the rear end. The drive end blade set 210 comprises an outer blade portion 211 and an inner blade portion 212. The outer blade portion 211 of the drive end blade set 210 draws the second air flow 181. The inner blade portion 212 of the drive end blade set 210 draws a third air flow 182 through the rear end air inlet 183 at the rear end of the housing 172. The inner blade portion 212 draws the third air flow 182 through the air gap 213 from the second fan side to the first fan side. The inner blade portion 212 expels the third air flow 182 with the second air flow 181 over the rear end stator windings 122 and out the sides of the housing 170, 171, 172 at the second rear end fan air outlet 185.

In a representative embodiment, the second air flow 181 is greater than the third air flow 182. In various embodiments, the dual-sided fan 160, 200 comprises a mounting wall 240 extending from the air deflecting wall 250. The mounting wall 240 is mounted to the rear end poles 113 by one or more of welding, screwing, or riveting. In certain embodiments, the separating wall 160, 330 is mounted to the rear end poles 113 by one or more of welding, screwing, or riveting. In a representative embodiment, each of the drive end blade set 210, 310 and the rear end blade set 220, 320 comprises a plurality of blades. The plurality of blades is one or more of straight, curved backward, or curved forward. In various embodiments, each of the drive end blade set 210, 310 and the rear end blade set 220, 320 comprises a plurality of blades. Each of the plurality of blades has a length that is one or more of a constant length, a variable length, or an alternating length.

Certain embodiments provide a method 400 for cooling electronics 130, 140 and rear end stator windings 122 of a stator assembly 120 of an alternator 100. The method 400 may comprise rotating 402 a dual-sided fan 160, 200, 300 disposed within a housing 170, 171, 172 of an alternator 100. The housing 170, 171, 172 may comprise a drive end, a rear end, and sides. The dual-sided fan 160, 200, 300 may be mounted to a rotor assembly 110 toward the rear end of the housing 170, 171, 172. The dual-sided fan 160, 200, 300 comprises a drive end blade set 210, 310 and a rear end blade set 220, 320 on opposite sides of a separating wall 230, 330. The method 400 may comprise drawing 404, by the rear end blade set 220, 320 of the dual-sided fan 160, 200, 300, a first air flow 180 through a rear end air inlet 183 at the rear end of the housing 172. The method 400 may comprise pulling 404, by the rear end blade set 220, 320, the first air flow 180 over electronics 130, 140 to transfer heat from the electronics 130, 140 to the first air flow 180. The method 400 may comprise expelling 406, by the rear end blade set 220, 320, the first air flow 180 out the sides of the housing 170, 171, 172 at a first rear end fan air outlet 184. The method 400 comprises drawing 402, by the drive end blade set 210, 310 of the dual-sided fan 160, 200, 300, a second air flow 181 through a drive end air inlet 191 at the drive end of the housing 170. The method 400 may comprise blowing 406, by the drive end blade set 210, 310, the second air flow 181 over rear end stator windings 122 of a stator assembly 120 to transfer heat from the rear end stator windings 122 of the stator assembly 120 to the second air flow 181. The method 400 may comprise expelling 406, by the drive end blade set 210, 310, the second air flow 181 out the sides of the housing 170, 171, 172 at a second rear end fan air outlet 185. In various embodiments, the second rear end fan air outlet 185 is positioned adjacent to the rear end stator windings 122 and the first rear end fan air outlet 184 is positioned between the second rear end fan air outlet 185 and the rear end of the housing 172.

In a representative embodiment, the first air flow 180 drawn through the rear end air inlet 183 and the second air flow 181 drawn through the drive end air inlet 191 are at ambient temperature. In various embodiments, the drive end blade set 210 comprises an outer portion 211 and an inner portion 212. The outer portion 211 of the drive end blade set 210 performs the drawing 404, blowing 406, and expelling 406 of the second air flow 181. In certain embodiments, the method comprises drawing, by the inner portion 212 of the drive end blade set 210, a third air flow 182 through a rear end air inlet 183 at the rear end of the housing 172. The method comprises pulling, by the inner portion 212 of the drive end blade set 210, the third air flow 182 over the electronics 130, 140 to transfer heat from the electronics 130, 140 to the third air flow 182. The method comprises drawing, by the inner portion 212 of the drive end blade set 210, the third air flow 182 from a second side of the dual-sided fan 160, 200 facing the rear end to a first side of the dual-sided fan 160, 200 facing the drive end. The third air flow 182 may be drawn from the second side to the first side through an air gap 213 in the dual-sided fan 160, 200. The method comprises blowing, by the drive end blade set 210, the third air flow 182 with the second air flow 181 over the rear end stator windings 122 of the stator assembly 120. The method comprises expelling, by the drive end blade set 210, the third air flow 182 with the second air flow 181 out the sides of the housing 170, 171, 172 at the second rear end fan air outlet 185.

In various embodiments, the second air flow 181 is greater than the third air flow 182. In a representative embodiment, the electronics 130, 140 comprise one or more of a regulator 140 and a rectifier assembly 130. In certain embodiments, each of the drive end blade set 210, 310 and the rear end blade set 220, 320 comprises a plurality of blades. The plurality of blades may be one or more of straight, curved backward, or curved forward. In various embodiments, each of the drive end blade set 210, 310 and the rear end blade set 220, 320 comprises a plurality of blades. Each of the plurality of blades has a length that is one or more of a constant length, a variable length, or an alternating length. In a representative embodiment, the rotor assembly 110 rotates the dual-sided fan 160, 200, 300. The rotor assembly 110 comprises drive end poles 112 and rear end poles 113. The separating wall 330 of the dual-sided fan 160, 300 is mounted to the rear end poles 113 by one or more of welding, screwing, or riveting.

Aspects of the present invention provide a dual-sided fan 160, 200. The dual-sided fan 160, 200 comprises a curved separating wall 230 having a first side and a second side. The dual-sided fan 160, 200 comprises a drive end blade set 210 extending from the first side of the curved separating wall 230. The drive end blade set comprises an outer portion 211 and an inner portion 212. The dual-sided fan 160, 200 comprises a rear end blade set 220 extending from the second side of the curved separating wall 230.

In various embodiments, the dual-sided fan 160, 200 comprises an air deflecting wall 250 defining a center opening 251 of the dual-sided fan 160, 200. The air deflecting wall 250 may be coupled to a portion of the inner portion 212 of the drive end blade set 210. The air deflecting wall 250 may be positioned to deflect air pulled by the inner portion 212 through an air gap 213 between the air deflecting wall 250 and the separating wall 230 if the dual-sided fan 160, 200 is rotated. In a representative embodiment, the dual-sided fan 160, 200 comprises a mounting wall 240 extending from the air deflecting wall 250 and configured to couple with a rotor assembly 110 of an alternator 100. In certain embodiments, each of the drive end blade set 210 and the rear end blade set 220 comprises a plurality of blades. The plurality of blades is one or more of straight, curved backward, or curved forward. In various embodiments, each of the drive end blade set 210 and the rear end blade set 220 comprises a plurality of blades. Each of the plurality of blades has a length that is one or more of a constant length, a variable length, or an alternating length.

As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.” and “for example” set off lists of one or more non-limiting examples, instances, or illustrations.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment or embodiments disclosed, but that the present invention will include all embodiments falling within the scope of the appended claims.

What is claimed is:

1. An alternator comprising:
a housing having a drive end, a rear end, and sides;
a rotor assembly having drive end poles and rear end poles, the drive end poles and the rear end poles disposed within the housing;
a stator assembly disposed within the housing and surrounding the drive end poles and the rear end poles, the stator assembly comprising drive end stator windings and rear end stator windings;
a dual-sided fan disposed within the housing and mounted to the rotor assembly adjacent to the rear end poles, the dual-sided fan comprising:
a separating wall having a first side and a second side,
a drive end blade set extending from the first side of the separating wall and at least partially facing the drive end, and
a rear end blade set extending from the second side of the separating wall and at least partially facing the rear end.

2. The alternator according to claim 1, wherein the dual-sided fan is rotatable by the rotor assembly, and wherein if the dual-sided fan is rotated:
the rear end blade set draws a first air flow through a rear end air inlet at the rear end of the housing and expels the first air flow out the sides of the housing at a first rear end fan air outlet toward the rear end from the rear end stator windings.
the drive end blade set draws a second air flow through a drive end air inlet at the drive end of the housing and expels the second air flow over the rear end stator windings and out the sides of the housing at a second rear end fan air outlet, wherein at least a portion of the rear end stator windings transfers heat to the second air flow.

3. The alternator according to claim 2, wherein the air drawn through the rear end air inlet and the drive end air inlet is ambient temperature air.

4. The alternator according to claim 2, comprising electronics disposed in the housing between the dual-sided fan and the rear end of the housing, wherein if the dual-sided fan is rotated the rear end blade set draws the first air flow over the electronics, and wherein at least a portion of the electronics transfers heat to the first air flow.

5. The alternator according to claim 2, wherein:
the dual-sided fan comprises:
a first fan side facing the drive end,
a second fan side facing the rear end,
an air deflecting wall, and
an air gap between the air deflecting wall and the separating wall,
the separating wall is curved toward the rear end,
the drive end blade set comprises an outer blade portion and an inner blade portion,
the outer blade portion of the drive end blade set draws the second air flow, and
the inner blade portion of the drive end blade set:
draws a third air flow through the rear end air inlet at the rear end of the housing,
draws the third air flow through the air gap from the second fan side to the first fan side, and
expels the third air flow with the second air flow over the rear end stator windings and out the sides of the housing at the second rear end fan air outlet.

6. The alternator according to claim 5, wherein the second air flow is greater than the third air flow.

7. The alternator according to claim 5, wherein the dual-sided fan comprises a mounting wall extending from the air deflecting wall, and wherein the mounting wall is mounted to the rear end poles by one or more of:
welding,
screwing, or
riveting.

8. The alternator according to claim 1, wherein the separating wall is mounted to the rear end poles by one or more of:
welding,
screwing, or
riveting.

9. The alternator according to claim 1, wherein each of the drive end blade set and the rear end blade set comprises a plurality of blades, and wherein the plurality of blades are one or more of:
straight,
curved backward, or
curved forward.

10. The alternator according to claim 1, wherein each of the drive end blade set and the rear end blade set comprises a plurality of blades, each of the plurality of blades having a length, and wherein the length is one or more of:
a constant length,
a variable length, or
an alternating length.

11. A method comprising:
rotating a dual-sided fan disposed within a housing of an alternator, the housing have a drive end, a rear end, and sides, the dual-sided fan mounted to a rotor assembly toward the rear end of the housing, the dual-sided fan comprising a drive end blade set and a rear end blade set on opposite sides of a separating wall;
drawing, by the rear end blade set of the dual-sided fan, a first air flow through a rear end air inlet at the rear end of the housing;
pulling, by the rear end blade set, the first air flow over electronics to transfer heat from the electronics to the first air flow;
expelling, by the rear end blade set, the first air flow out the sides of the housing at a first rear end fan air outlet;
drawing, by the drive end blade set of the dual-sided fan, a second air flow through a drive end air inlet at the drive end of the housing;
blowing, by the drive end blade set, the second air flow over rear end stator windings of a stator assembly to transfer heat from the rear end stator windings of the stator assembly to the second air flow; and
expelling, by the drive end blade set, the second air flow out the sides of the housing at a second rear end fan air outlet,
wherein the second rear end fan air outlet is positioned adjacent to the rear end stator windings and the first rear end fan air outlet is positioned between the second rear end fan air outlet and the rear end of the housing.

12. The method according to claim 11, wherein the first air flow drawn through the rear end air inlet and the second air flow drawn through the drive end air inlet are at ambient temperature.

13. The method according to claim 11, wherein the drive end blade set comprises an outer portion and an inner portion, and wherein the outer portion of the drive end blade set performs the drawing, blowing, and expelling of the second air flow.

14. The method according to claim 13, comprising:
drawing, by the inner portion of the drive end blade set, a third air flow through a rear end air inlet at the rear end of the housing;
pulling, by the inner portion of the drive end blade set, the third air flow over the electronics to transfer heat from the electronics to the third air flow;
drawing, by the inner portion of the drive end blade set, the third air flow from a second side of the dual-sided fan facing the rear end to a first side of the dual-sided fan facing the drive end, wherein the third air flow is drawn from the second side to the first side through an air gap in the dual-sided fan;
blowing, by the drive end blade set, the third air flow with the second air flow over the rear end stator windings of the stator assembly; and
expelling, by the drive end blade set, the third air flow with the second air flow out the sides of the housing at the second rear end fan air outlet.

15. The method according to claim 14, wherein the second air flow is greater than the third air flow.

16. The method according to claim 11, wherein the electronics comprise one or more of a regulator and a rectifier assembly.

17. The method according to claim 11, wherein each of the drive end blade set and the rear end blade set comprises a plurality of blades, and wherein the plurality of blades are one or more of:
straight,
curved backward, or
curved forward.

18. The method according to claim 11, wherein each of the drive end blade set and the rear end blade set comprises a plurality of blades, each of the plurality of blades having a length, and wherein the length is one or more of:
a constant length,
a variable length, or
an alternating length.

19. The method according to claim 11, wherein the rotating the dual-sided fan is by the rotor assembly, wherein the rotor assembly comprises drive end poles and rear end poles, and wherein the separating wall of the dual-sided fan is mounted to the rear end poles by one or more of:
welding,
screwing, or
riveting.

20. A dual-sided fan comprising:
a curved separating wall having a first side and a second side;
a drive end blade set extending from the first side of the curved separating wall, the drive end blade set comprising an outer portion and an inner portion; and
a rear end blade set extending from the second side of the curved separating wall.

21. The dual-sided fan according to claim 20, comprising an air deflecting wall defining a center opening of the dual-sided fan, the air deflecting wall coupled to a portion of the inner portion of the drive end blade set, the air deflecting wall positioned to deflect air pulled by the inner portion through an air gap between the air deflecting wall and the separating wall if the dual-sided fan is rotated.

22. The dual-sided fan according to claim 21, comprising a mounting wall extending from the air deflecting wall and configured to couple with a rotor assembly of an alternator.

23. The dual-sided fan according to claim 20, wherein each of the drive end blade set and the rear end blade set comprises a plurality of blades, and wherein the plurality of blades are one or more of:
straight,
curved backward, or
curved forward.

24. The dual-sided fan according to claim 20, wherein each of the drive end blade set and the rear end blade set comprises a plurality of blades, each of the plurality of blades having a length, and wherein the length is one or more of:
a constant length,
a variable length, or
an alternating length.
